(19) United States
(12) Patent Application Publication
(10) Pub. No.: US 2015/0310176 A1
(43) Pub. Date: Oct. 29, 2015

(54) HEALTHCARE EVENT RESPONSE AND COMMUNICATION CENTER

(71) Applicant: DrFirst.com, Inc., Rockville, MD (US)

(72) Inventors: James F. Chen, Potomac, MD (US); Chen Qian, Vienna, VA (US); Zilong Tang, Rockville, MD (US)

(21) Appl. No.: 14/694,539

(22) Filed: Apr. 23, 2015

Related U.S. Application Data
(60) Provisional application No. 61/984,008, filed on Apr. 24, 2014.

(51) Int. Cl. G06F 19/00

(52) U.S. Cl. CPC G06F 19/324; G06F 19/322

(57) ABSTRACT

The present teaching relates to a Healthcare Event Response and Communication Center. In one example, a healthcare message is received. The healthcare message is processed to automatically identify one or more healthcare events. For each identified healthcare event, one or more responsive entities that are configured to be responsive to the healthcare event are identified. Each responsive entity is associated with one or more healthcare workflows that are configured to receive the healthcare event. Each identified healthcare event is provided in real-time to each of the one or more responsive healthcare workflows with respect to each responsive entity.

### CROSS-REFERENCE TO RELATED APPLICATION

The present application claims priority to the U.S. Provisional Patent Application No. 61/984,008, filed on Apr. 24, 2014, entitled “METHOD AND SYSTEM FOR MULTISOURCE RESPONSIVE HEALTH DATA SWITCH,” which is incorporated herein by reference in its entirety.

### TECHNICAL FIELD

The present teaching relates to methods, systems and programming for networked computer systems. Particularly, the present teaching is directed to methods, systems, and programming for an event driven workflow system that automatically and timely delivers healthcare information to patients and healthcare professionals of various healthcare organizations.

### BACKGROUND

Lack of proper communication and collaboration among related entities has been identified as a leading cause of errors, for example, in case of health care industry, medical errors, affecting both patient safety and the rising cost of healthcare in the United States. In one example, the healthcare system's current inability to collaborate across healthcare organizations has resulted in patients unnecessarily being readmitted to the hospital within days after previous hospital discharge. Many Readmissions can be prevented if the patient receives appropriate follow up care. However, many patients do not receive necessary follow up care simply because their primary care and specialist physicians are not made aware of the patient's hospitalization.

Timely communications between hospitals, physicians and patients are needed to improve the delivery of care. Preventable hospital readmissions burden our health system with excessive costs. In fact, the Affordable Care Act (ACA) implemented the Hospital Readmissions Reduction Program that requires the Centers for Medicaid and Medicare Services to reduce payments to IPPS (Inpatient Prospective Payment System) hospitals with excess readmissions. Physicians are in dire need of technology to assist them in remembering important steps or accessing clinical data needed in caring for their patients. Empowering physicians with timely access to clinical content allows immediate facilitation of follow-up care thus reducing patient re-admission risk and providing improved patient care outcomes.

Similarly, communication and collaboration of inter-disciplinary team of heath care service providers is critical in many other situations, such as, for example, when a patient has multiple health problems; or when a patient sees multiple specialists; or when a patient is transitioned between care settings; or when a patient is receiving treatment in emergency settings.

### SUMMARY

The teachings disclosed herein relate to methods, systems, and programming for an event driven workflow system that that uses an automated approach to manage the release of information with predesigned workflows.

In one example, a method, implemented on at least one computing device having at least one processor, storage, and a communication platform connected to a network for handling healthcare messages from various entities in a healthcare community is disclosed. A healthcare message is received. The healthcare message is processed to automatically identify one or more healthcare events. For each identified healthcare event, one or more responsive entities that are configured to be responsive to the healthcare event are identified. Each responsive entity is associated with one or more healthcare workflows that are configured to receive the healthcare event. Each identified healthcare event is provided in real-time to each of the one or more responsive healthcare workflows with respect to each responsive entity.

In another example, method, implemented on at least one computing device having at least one processor, storage, and a communication platform connected to a network for dynamically generating healthcare workflows is disclosed. A healthcare event is received as associated with a responsive entity. One or more healthcare workflows that are associated with the healthcare event and the responsive entity are identified. The identified one or more healthcare workflows are instantiated while applying configurations that are associated with the responsive entity. Each instantiated healthcare workflow is executed based on information that relates to the received healthcare event.

In a different example, a system for handling healthcare messages from various entities in a healthcare community is disclosed. The system includes a message processor, an event trigger logic, an event subscription module, and an event generator. The message processor is configured to receive a healthcare message and process the healthcare message. The event trigger logic is configured to automatically identify one or more healthcare events. The event subscription module is configured to identify, for each identified healthcare event, one or more responsive entities that are configured to be responsive to the healthcare event. Each responsive entity is associated with one or more healthcare workflows that are configured to receive the healthcare event. The event generator is configured to provide, in real-time, each identified healthcare event to each of the one or more responsive healthcare workflows with respect to each responsive entity.

In another example, a system for dynamically generating healthcare workflows is disclosed. The system includes an event to workflow index unit and a workflow engine. The event to workflow index unit is configured to receive a healthcare event as associated with a responsive entity and identify one or more healthcare workflows that are associated with the healthcare event and the responsive entity. The workflow engine configured to instantiate the identified one or more healthcare workflows while applying configurations that are associated with the responsive entity. The workflow engine is further configured to execute each instantiated healthcare workflow based on information that relates to the received healthcare event.

Other concepts relate to software for implementing the present teaching on Healthcare Event Response and Communication Center. A software product, in accord with this concept, includes at least one non-transitory machine-readable medium and information carried by the medium. The information carried by the medium may be executable program code data, parameters in association with the executable program code, and/or information related to a user, a request, content, or information related to a social group, etc.

In one example, a non-transitory machine readable medium having information recorded thereon for handling healthcare messages from various entities in a healthcare community is disclosed. The recorded information, when read by the machine, causes the machine to perform a series of processes. A healthcare message is received. The healthcare message is processed to automatically identify one or more healthcare events. For each identified healthcare event, one or more responsive entities that are configured to be responsive to the healthcare event are identified. Each responsive entity is associated with one or more healthcare workflows that are configured to receive the healthcare event. Each identified healthcare event is provided in real-time to each of the one or more responsive healthcare workflows with respect to each responsive entity.

In another example, a non-transitory machine readable medium having information recorded thereon for dynamically generating healthcare workflows is disclosed. The recorded information, when read by the machine, causes the machine to perform a series of processes. A healthcare event is received as associated with a responsive entity. One or more healthcare workflows that are associated with the healthcare event and the responsive entity are identified. The identified one or more healthcare workflows are instantiated while applying configurations that are associated with the responsive entity. Each instantiated healthcare workflow is executed based on information that relates to the received healthcare event.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1(a) describes a high level depiction of a system configurations, according to an embodiment of the present teaching;

FIG. 1(b) is a high level depiction of an exemplary entity rules, according to an embodiment of the present teaching;

FIG. 2 is a flowchart of an exemplary process in which an Healthcare Event Response and Communication Center operates, according to an embodiment of the present teaching;

FIG. 3(a) is a high level depiction of an exemplary event center, according to an embodiment of the present teaching;

FIG. 3(b) is a flowchart of an exemplary flowchart of an exemplary process in which an event center operates, according to an embodiment of the present teaching;

FIG. 4(a) shows an exemplary system diagrams of a workflow system, according to an embodiment of the present teaching;

FIG. 4(b) is a flowchart of an exemplary flowchart of an exemplary process in which an workflow system operates, according to an embodiment of the present teaching

FIG. 4(c) shows an exemplary user interface where the recipient rules for a recipient are defined;

FIG. 5 shows an exemplary system diagrams of a delivery engine, according to an embodiment of the present teaching;

FIG. 6 shows exemplary workflow diagrams, according to an embodiment of the present teaching;

FIG. 7 depicts the architecture of a computing device which can be used to realize a specialized system implementing the present teaching; and

FIG. 8 depicts the architecture of a mobile device which can be used to realize a specialized system implementing the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

Example embodiments are described with regard to health related entities as sources of health related data, however, the embodiments are not limited to the health industry and the inventive concepts can be applied to industries in which intelligent and dynamic collaboration among entities is needed. To solve the problem associated with ineffective communication and care collaboration, the inventors invented the Healthcare Event Response and Communication technology that enables collaboration of a care team among different healthcare organizations by providing an event driven workflow system that uses an automated approach to manage the release of information with predesigned workflows; and by providing a mechanism for real-time, cross organization communication.

As a result of this proactive approach, the patient information is timely and readily available to a care team (i.e., Primary care physician, Referring physician, consulting physician etc. relate to the patient). Additionally, timely collaboration of the care team cross different organizations in view of the provided patient information leads to better quality of care, improved patient outcomes, reduced medical errors, and reduced unnecessary tests.

Additionally, the Healthcare Event Response and Communication technology allows patient involvement as it incorporates patient's own healthcare management system and the patient's personal health records (PHRs).

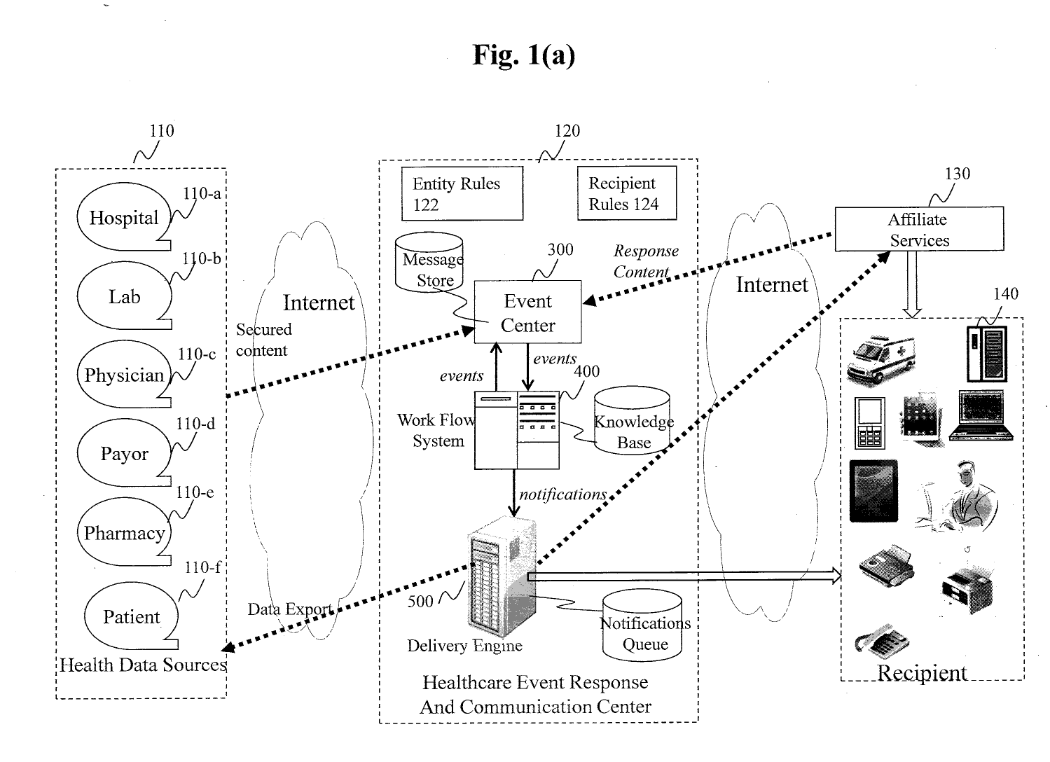

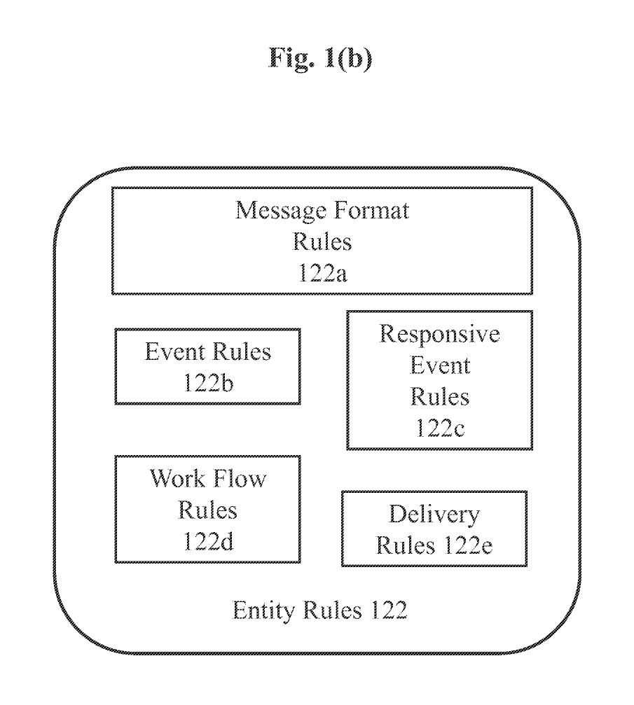

The present teaching may be implemented in architecture as shown in FIG. 1(a), as one possible embodiment. In this embodiment, a Health Data Sources 110 comprises various healthcare entities, such as an array of HIE vendors, organizations, and regional subnet works, that will exchange or transfer Electronic Health Records (EHR) in a trust frame work. EHRs can be created, managed, and consulted by authorized providers and staff across more than one health care organization. EHRs may include information about a patient's medical history, diagnoses, medications, immunization dates, allergies, radiology images, and lab and test results. EHRs may also include real-time, patient-centered records. A single EHR may bring together information about a patient from current and past doctors, emergency facilities, school and workplace clinics, pharmacies, laboratories, and medical imaging facilities.

The trust frame work is established by, for example, authorized entities that provide trust assurance of data maintenance and use, as supported by their contact agreements. The trust frame work of the Health Data Sources 110 allows trusted secure exchange of EHR and other clinical information. In one example, the EHR is exchanged in the form of secured messages by Health Information Service Providers (HISP). In another example, the EHR is exchanged in the form of documents in the health information exchange (HIE), using document formats, such as, for example, Continuity of Care Document (CCD), Clinical Document Architecture (CDA), Electronic Data Interchange (EDI) and Health Level 7 documents (HL7).

A method and system is provided capable of deriving responsive data events to a source data event from a plurality of computer implemented data sources of a plurality of entities, by generating responsive event rules for the data sources of the entities; in response to the source data event, applying the responsive event rules to the information associated with the source data event to derive responsive data events for a plurality of entities; processing the derived responsive data events to initiate respective workflows for the plurality of entities associated with the responsive data events. The source data event can be generated by generating event rules for the data sources of the entities; detecting a source data event from a source entity based on an event rule of the source entity and the information associated with the source data event; and processing the source data event to initiate a corresponding workflow for the source entity. The applying the responsive event rules to the information associated with the source data event includes selecting one or many responsive event rules based on the source data event; determining, for each selected responsive event rule, whether the information associated with the source data event satisfies the responsive event rule. The detecting a source data event can be by applying trigger logic of the event rule to the information associated with the source data event. The entities include one or more of a hospital, a lab, a physician, a payer, a pharmacy, or a patient. As shown in FIG. 1, the trust frame work of the Health Data Sources 110 may include various types of entities or organizations. For example, the Health Data Sources 110 may include a number of hospitals, as represented as a Hospital 110-a; the Health Data Sources 110 may also include a number of labs which provides clinical lab data of patients, as represented as a Lab 110-b. The Health Data Sources 110 may also include a number of provider facilities that have access to the HIE system, as represented as a Physician 110-c. The Health Data Sources 110 may also include one or many payers, as represented as Payers 110-d, which include, for example, health insurance companies in the HIE system that provide payments to the Hospital 110-a, the Lab 110-b, the Physician 110-c, or the Pharmacy 110-e.

The Health Data Sources 110 may also include one or many pharmacies, as represented as a Pharmacy 110-e, which handle prescriptions for a patient, or which handle prescriptions from the Hospital 110-a or from the Provider 110-b. The Health Data Sources 110 may also include one or many patients' personal health record (PHR) system, who are members of the trust frame work, as represented as a Patient 110-f. For example, a patient may maintain and track his personal health record in a MICROSOFT HEALTH VAULT system.

The Health Data Sources 110 may also include other organizations or members of the trusted community which maintain Electronic Medical Records (EMR) or Electronic Health Records (EHR) or Personal Health Records (PHR).

A healthcare entity in the Health Data Sources 110 may proactively communicate with other healthcare entities in the trust frame work by sending standardized secure messages upon occurrence of a real-life event. For example, a hospital 110-a may want to send messages upon the occurrence of a patient event, such as, when the patient is admitted, discharged or transferred from the hospital 110-a, (ADT messages). The hospital 110-a may also want to send messages upon creation of an important document relate to a patient, such as, for example, a patient discharge summary (PDS) that includes a record of the patient hospital care and recommended follow up care.

For example, the hospital 110-a may want to send messages along with the important PDS document to the patient's care team, including, for example, a primary care physician, specialists or other members of a follow up care team. The follow up care team may include, for example, other treating physicians as suggested by the patient's record, or physicians, specialists, as indicated in the patient discharge summary document. In another example, a lab 110-b may want to automatically send clinical lab results, the moment the lab result is ready, to the subject patient's primary care physicians, in addition to the entity who has ordered the lab test.

Alternatively, the healthcare entity in the Health Data Sources 110 may communicate in response to an EHR request by a trusted entity in the trust frame work. For example, a primary care physician 110-c of a patient maintains the patient's medical history, diagnoses, medications, immunization dates, allergies, radiology images, and lab and test results. An emergency care doctor, who is in the same trust network with the primary care physician, on an ambulance may simply request access to the EHR of a patient from the patient's primary care physician 110-c. By responding to the EHR access request, physician 110-c provides to the emergency care doctor with information needed to make immediate treatment decisions.

A Healthcare Event Response and Communication Center 120 is a trusted entity to the healthcare entities of the health data sources 110, as it is contracted and configured to communicate with each entity individually. Acting as an information hub connected to different entities in the health data sources 110, the Healthcare Event Response and Communication Center 120 manages the release of information obtained from various source entities to various receiving entities with predesigned workflows. The Healthcare Event Response and Communication Center 120 also provides a mechanism for information recipients to respond to the notified information with real-time, cross organization communication systems, such as a chat system, for example, AKARIO BACKLINE CHAT by DRFIRST.

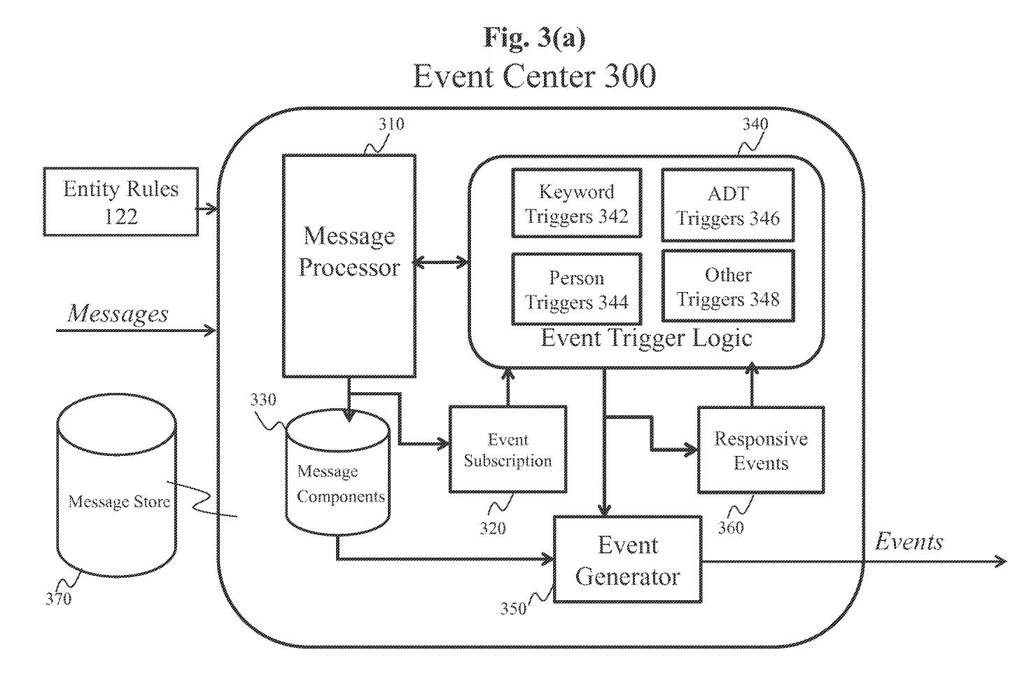

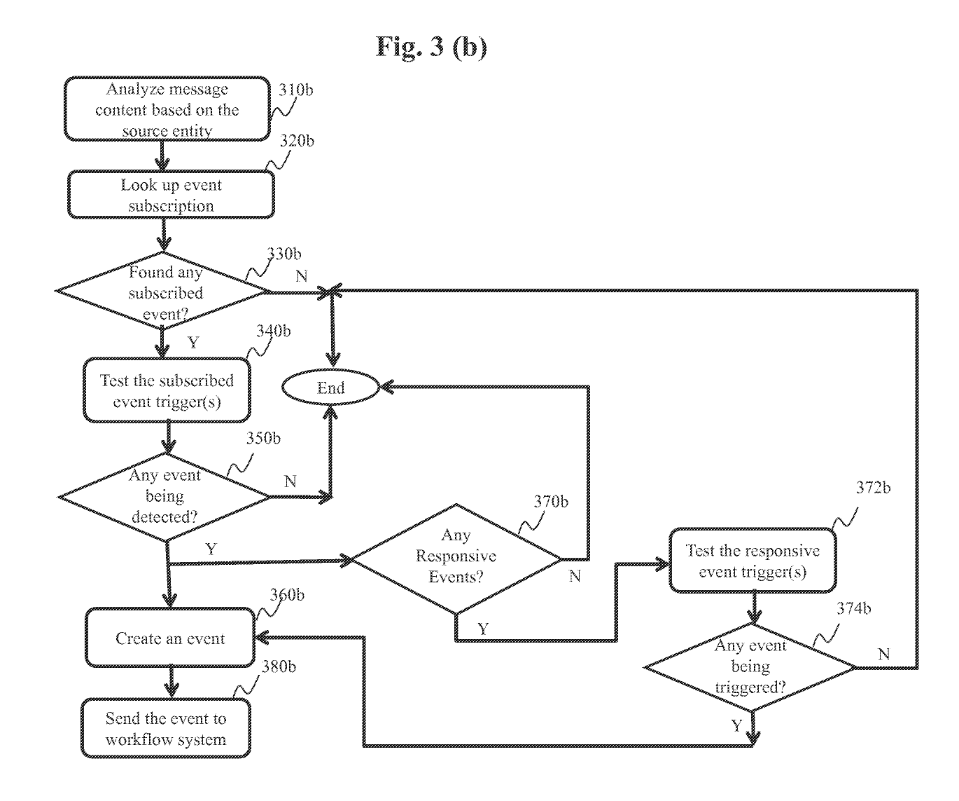

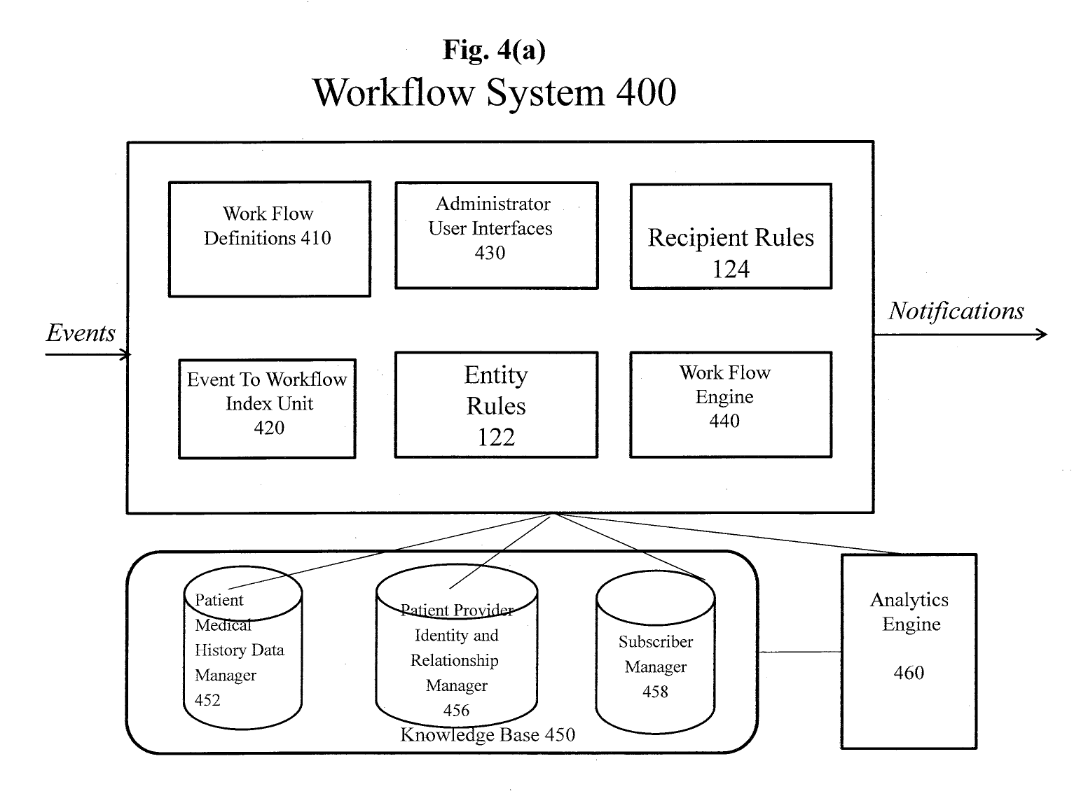

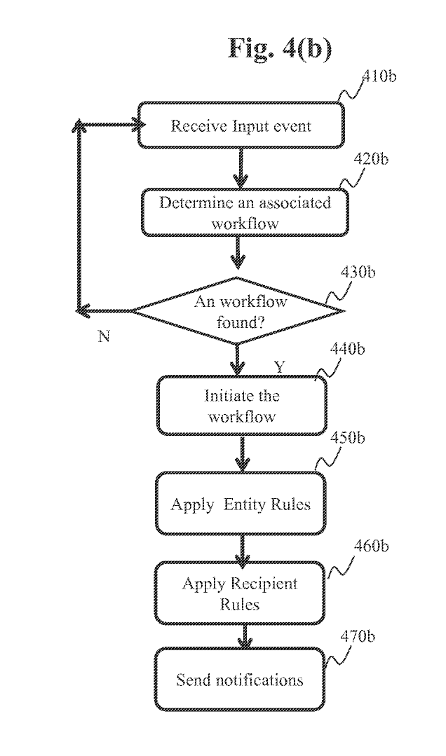

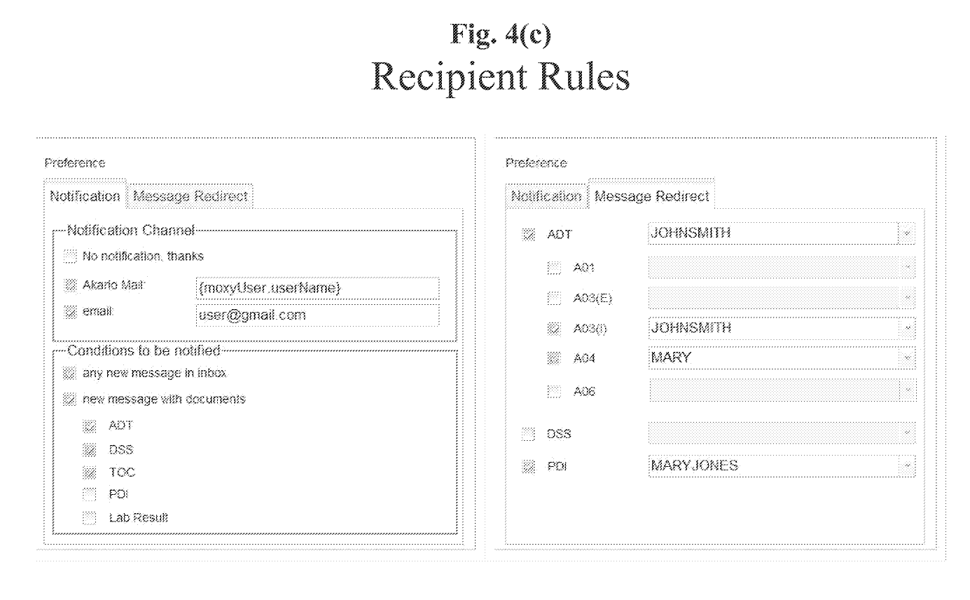

The Healthcare Event Response and Communication Center 120 includes an entity rule 122 component that is configurable to capture the communication rules or protocols for each healthcare entity in the health data sources 110, as discussed in more detail in FIG. 3(a) and FIG. 4(a).

In reference to FIG. 1(b), the entity rule 122 may include message format rules 122a which are rules configured to interpret messages of various formats communicated by the associated entity. The entity rule 122 may also include event rules 122b, such as, for example, a set of events and their respective trigger logic/conditions for the entity.

The entity rule 122 may also include responsive event rules 122c, which includes a set of events from external entities that may trigger one or more events for the associated entity. The details are described below in description relate to FIGS. 3(a)-3(b).

The entity rule 122 may also include workflow rules 112d that may be incorporated into the workflow system to configure specific workflows for the organization/entity. The details are described below in description relate to FIGS. 4(a)-4(c). For example, hospital A, as an organization, set a default rule to send ADT messages to all physicians that are identified in the patient's discharge summary. In contrast, hospital B, set its default rule to send ADT messages to physicians as limited to those whose role be a primary care physician for the patient.

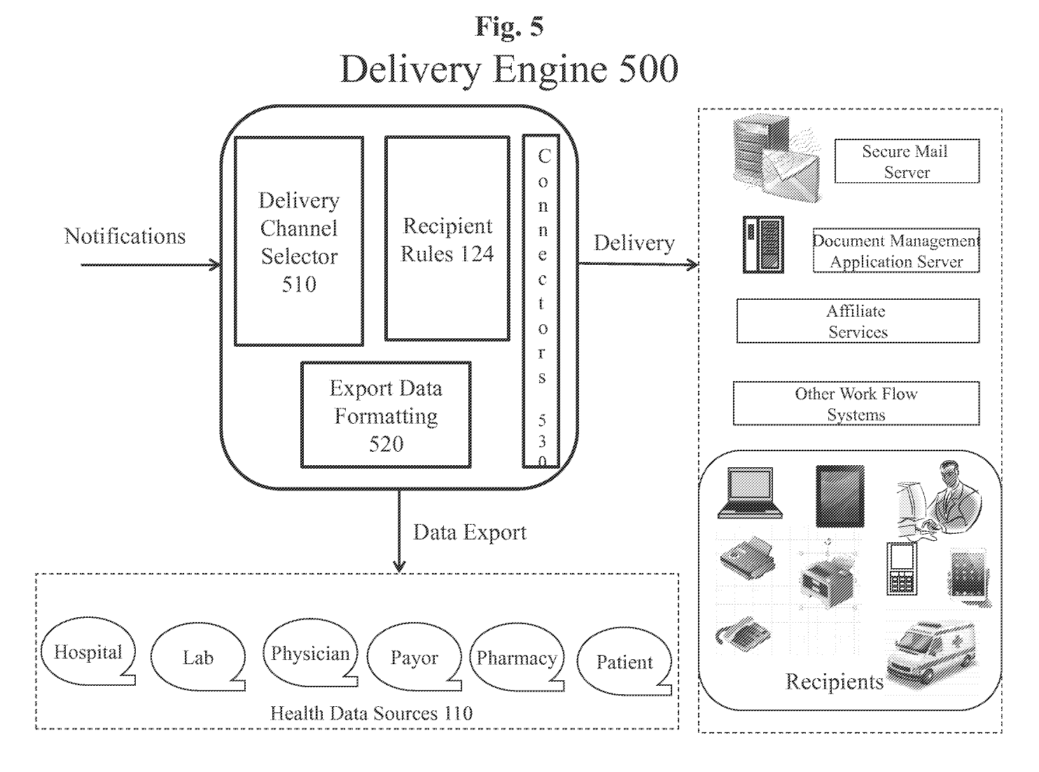

Additionally, the entity rule 122 may also include delivery rules 122e on how a notification would be delivered. The details are described below in description relate to FIG. 5.

A recipient, typically a human user of a receiving entity/organization, includes physicians, nurses, care coordinators, healthcare staff or patients. The recipient may become alert fatigued due to the volume of the alerts. The recipient may also prefer not to be constantly alerted for matters that the recipient is not interested. A recipient rule 124 components in the Healthcare Event Response and Communication Center 120 is configurable to capture the rules or preferences relate to each recipient. The recipient rule 124 may include recipient's preferences with respect to the content selection, timing and delivery mechanisms for various types of notifications.

More specifically, the recipient rules 124 may include notifications that the recipient elects to receive based on the content of the notifications. For example, a specialized physician in a research hospital may elect to receive patient discharge summaries when it includes a diagnosis of disease x. In one example, a physician of a hospital may prefer to receive all alerts that are directed to him by the hospital. In another example, a physician may alternatively, define his preference rules to receive alerts based on some specific criteria. For example, the physician may prefer to receive alerts as limited to situations when the alert comes from an emergency care facility or an ambulance.

The recipient rules 124 may also include rules as to the delivery schedule of the notification. The recipient rules 124 may include rules relate to the recipient's preference based on his own daily schedule or workflow. For example, a surgeon may prefer not to be interrupted by any notifications when he is in the operating room.

The recipient rules 124 may also include the preferred receiving device for a type of notification. The recipient rules 124 may also include alternative receiving device for a failed notification. The recipient rules 124 may also include an alternative recipient, such as a nurse or care coordinator, for receiving a particular type of notifications for the targeted recipient.

The Healthcare Event Response and Communication Center 120 enables collaboration among individuals from various entities in the health data sources 110 because it allows interactions by individuals from different entities/data sources via a shared workflow system.

A workflow system is operable to use real-time information to take automated action based on pre-defined rules. The workflow system also assists in collaboration and integration with other systems. The workflow system allows human interaction, as a result, the workflow can adjusts to changing demands, and business processes—allowing users to continually optimize the process, comply with emerging policies and regulations.

Being a trusted entity to a community of healthcare entities, the Healthcare Event Response and Communication Center 120 has advantage in the breath of data it can access. First, the Healthcare Event Response and Communication Center 120 has immediate access to the news data, i.e., data communicated currently in the healthcare community of health data sources 110. Second, the Healthcare Event Response and Communication Center 120 has direct access to data that is communicated through the Healthcare Event Response and Communication Center 120 historically, as the Healthcare Event Response and Communication Center 120 may store accessed data in its own data repository for a period of time.

The more a user use the Healthcare Event Response and Communication Center 120, the more the Healthcare Event Response and Communication Center 120 knows the user as it keeps data relevant to users in direct and fast access. Third, the Healthcare Event Response and Communication Center 120 has access to historical data within its trusted network that are public or private (such as data pertain to selected group of patients or providers based on preset privacy agreements).

The Healthcare Event Response and Communication Center 120 may also serve as a content source and provide value-added data to the healthcare community. For example, with its analytics ability, the Healthcare Event Response and Communication Center 120 may provide knowledge or insights obtained from analyzing accessible data from different entities in various perspectives. In another example, the Healthcare Event Response and Communication Center 120 may provide predictions, warnings or alerts for potential future issues via its predictive analytics ability. The knowledge or predictions provides healthcare professionals additional source for making decisions.

The Healthcare Event Response and Communication Center 120 includes an event center 300 which is operable to receive data messages from various entities in the health data sources 110. As discussed further in FIGS. 3(a)-3(b), the event center 300 may leverage entity rules 122 in identifying the source of the document/message, interpreting the message/document.

The Healthcare Event Response and Communication Center 120 includes a work flow system 400 which is driven by events received from the event center 300. The workflow system 400 includes a collection of workflows as pertained to various entities in the health data source 100. A workflow typically includes a sequence of tasks, the people required to execute each task and the data needed to execute each task. In one embodiment of the present teaching, the workflow system 400 processes received data events and generate notifications. A notification is a deliverable data package targeted at a list of recipients. An activated workflow may generate, for example, a sequence of notifications, the targeted recipients to the notifications and the data messages or documents to be delivered with the notifications.

The workflow system 400 increases the efficiency of notification delivery because it is able to route the right information to the right person or machine at the right time. The workflow system also increases the consistency and quality of information delivery because it can be designed to follow the rules of the best practices. The workflow system 400 also provides a generic framework that can be adapted to a wide variety of notification delivery processes.

The Healthcare Event Response and Communication Center 120 includes a delivery engine 500 that delivers health information customized to a recipient. As discussed further in FIG. 5, the delivery engine 500 may leverage the recipient rules 124 to configure how the message is delivered.

In one embodiment of the present teaching, the delivery engine 500 delivers the notification immediately. In another embodiment of the present teaching, the delivery engine batch delivers the notification in a predefined time. For example, a physician prefers to receive all non-urgent notifications at the end of the day, instead of receiving them upon its occurrence. In another embodiment of the present teaching, a subscriber would receive statistics of a certain event on a weekly or monthly basis. The delivery engine 500 may include a Notifications Queue to store and manage its notifications and deliveries.

Affiliate services 130 include service providers that are configured to communicate with the Healthcare Event Response and Communication Center 120. For example, a secured chat system AKARIO BACKLINE chat by DRFIRST allows members from different organizations, such as doctors, nurses, specialists, or a hospital staff to participate in a chat relate to a particular patient. In another example, subscribers from different organizations who subscribe to a particular topic may initiate a real-time chat on a specific topic. In still another example, a provider may receive all notifications from hospitals in a secure email system, such as, for example, DRFIRST's AKARIO MAIL.

Recipient 140 generally refers to human users, such as healthcare professionals (i.e., physicians, nurses, care coordinators) or patients. Recipient 140 may also include other users configured to receive services from the Healthcare Event Response and Communication Center 120. For example, subscribers of reports from the Healthcare Event Response and Communication Center 120's analytics. The human user of recipient 140 can be reached by various devices. For example, a human user may be reached by a mobile device that he/she normally carries, such as a smart phone, a mobile phone, an iPad, an iPad mini or a laptop computer. In another example, the human user may be reached by a desktop computer. In still another example, the human user may be reached voicemail through a telephone or answer machine. In still another example, the human user may be reached by a fax machine. In still another example, the human user may be reached by systems that are built in an ambulance.

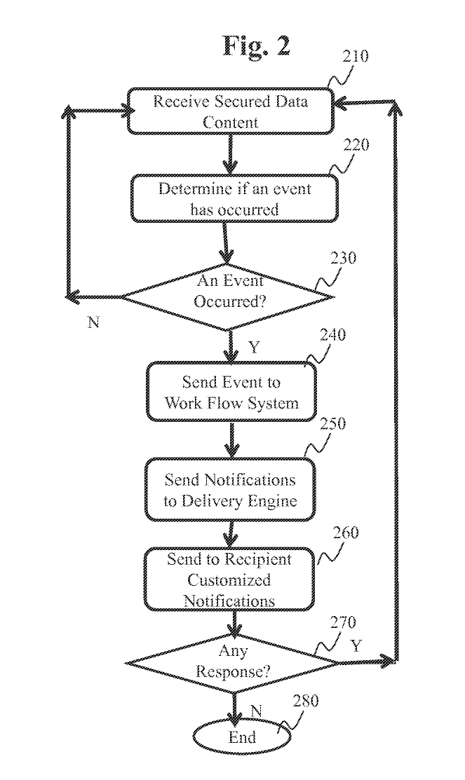

FIG. 2 is a flowchart of an exemplary process in which a Healthcare Event Response and Communication Center 120 operates, according to an embodiment of the present teaching. Upon receiving secured data content, such as a message, from health data source 110 at 210, the event center 300 processes the message and determines if an event has occurred at 220. If an event occurred at 230, the event center 300 sends the event to the workflow system 400.

The workflow system 400 processes the event with pre-defined workflows and assembles one or more notifications relate to the event. The workflow system 400 sends the notification to the delivery engine 500 at 250. The delivery engine 500 assembles customized delivery content for each notification, uses preferred delivery channel of the recipient and delivers the customized notification to the recipient at 260. If the recipient has any response upon receiving the notification at 270, the response will be send to the event center 300 and restart the same process starting at 210.

FIG. 3(a) is a high level depiction of an exemplary event center 300, according to an embodiment of the present teaching. The event center 300 is operable to communicate with multiple different entities in the health data source 110, each entity may communicate with a number of message types. In one example, a lab may send a HL7 message indicating a lab result is available. In another example, a lab may send a HL7 message indicating the finding of critical lab test values. In another example, a pharmacy may send a HL7 message indicating that a medication non-adherence alert of a particular patient. In another example, a provider may send a HL7 message indicating that a follow-up care non-adherence of a particular patient. In another example, a hospital may send a HL7 message indicating a readmission early warning alert.

An event is a predefined set of conditions that identify the occurrence of an event in view of a received message. The event may be identified when the content of the received message satisfies the set of the conditions predefined for the event. An identified event may cause an action to be initiated, such as, for example, initiating one or more workflows in the workflow system 400, as described further in FIGS. 4(a)-4(c).

The event center 300 receives messages from one or many entities in the health data source 110, identifies events based on the received message and whether a pre-defined event has occurred.

An event may be defined by a Healthcare Event Response and Communication Center 120 administrator. An event may be defined by an organization, such as a hospital or a lab. An event may be defined based on a subscriber's selection of a certain topic or a set of keywords. An event is typically identified via the content of a received message.

Upon receiving one message from one entity of a particular type, the event center 300 is operable to generate one or more events that initiate workflows in one or more entities based on the received message. In one example, a (patient discharge instruction) PDI message of hospital A may generate a first event whereby hospital A's workflow for sending PDI notification may be initiated. In another example, the same message from hospital A may generate a second event to initiate a second workflow for hospital A for monitoring the subject patient's follow up care.

Additionally, the same message from hospital A may generate events for one or more external entities, other than the message source entity, i.e., the hospital A. For example, the PDI message from hospital A may generate a 3^{rd} event for a first external entity: a provider facility, such as, for example a private practice clinic associated with a follow up physician as identified in the patient discharge message. The 3^{rd} event may initiate a workflow in the private practice clinic to watch for the subject patient's visit within a time period and to communicate with the hospital A on the status of the subject patient's follow up care.

Moreover, the same message from hospital A may generate a 4^{th} event for a second external entity, such as, for example, a pharmacy for required prescriptions as indicated by the PDI message. The 4^{th} event may initiate a workflow in the pharmacy entity to watch for the subject patient's prescription filling status and to communicate with the hospital A on the status of the subject patient's medication adherence.

In summary, by allowing messages from one entity to trigger events and workflows in one or more other entities, the present teaching provides a mechanism to enable timely collaboration among different entities based on real-time data content.

The event center 300 includes a message processor 310 operable to process raw messages received from different entities in the health data source 110 and to extract meaningful content based on the raw message.

The message processor 310 is operable to identify the source entity of the raw message, such as whether the raw message is from hospital A or hospital B, or Lab X or Lab Y. The message processor 310 is also operable to identify the type of the raw message, such as whether it is an ADT message, a PDI message, a message that includes a CCD document, a message that includes a CDA document, a message that includes an EDI document or any other types of message. The message processor 310 may determine the source entity and the message type typically by analyzing the header portion of the raw message.

The message processor 310 may further extract meaningful content from the body of the raw message based on the source entity and message type of a received raw message. More specifically, the message processor 310 may apply appropriate message format rules that are specific to the source entity to extract meaningful content from the raw message.

Moreover, the message processor 310 may also provide Application Programming Interface (API) as a mechanism for defining a new message types and for extracting meaningful contents from messages of the new message type.

Hospitals typically follow the HL7 message standard when sending out ADT messages. HL7 is a medical health informatics standard which provides a framework (and related standards) for the exchange, integration, sharing, and retrieval of electronic health information. Health information that is common across organizations (for example, patient demographics and patient events such as admission, discharge, and transfer) has a specified format and codes that can be incorporated into all EMRs.

Under the HL7 standard, different hospitals may still vary in its ADT message definition. In one embodiment of the present teaching, the message processor 310 provides a user interface for an organization, such as a hospital, to configure its message formats. In another embodiment of the present teaching, the message processor 310 may reference message configurations as defined in the entity rule 122 through a separate user interface for the entity rule 122.

The message processor 110 may extract various types of meaningful contents to construct specific message components. For example, using a PDI message, the message processor 110 may construct a message source component, a message type component, a message content component, a subject patient component, and one or more provider component which includes provider identity as well as the provider's role in relation to the subject patient, as stated in the PDI message.

In one example, the message processor 110 may provide its message components directly to the event trigger logic 340 to trigger events. In another example, the message processor 110 may store the message components in the message components 330. In another example, the message processor 310 may provide message components to the event subscription 320.

In one example, the message processor 310 parses a raw message to extract all key words in the raw message. For example, the message processor 310 extracts known key words, such as, for example, known disease names, symptom names, known drug names, such as, for example, “diabetes,” “headaches,” “Metformin,” etc. In another embodiment, the message processor 310 extracts key words by extracting all words from the raw message except for a list of words that provides no meaning: “the,” “for,” “report,” “status,” etc. In another embodiment, the message processor 310 extracts keywords that are used in the keyword triggers 342.

Additionally, the message processor 310 may also extract information that identifies a person. For example, the message processor 310 may extract a patient's identity information, such as name (first name, last name, middle name, date of birth, or an account number, such as, for example, an account number that the person associated with in the message source entity, or an universal identification number for the patient. In another example, the message processor 310 may extract provider's identity information, such as a doctor's name (first name, last name), associated facility, or an identification number associated with the doctor.

In one example, a hospital routinely sends HL7 ADT messages for events that relate to a patient's admission discharge and transfer. More specifically, ADT messages may report events such as an admission to emergency department event, an admission to hospital as an inpatient event, a discharge from emergency department event, and discharge from hospital as an inpatient event. As described in more detail below, these 4 events may be identified by the message types, for example, by the value in A HL7 segment MSH-9.

TABLE 1
Events corresponding to message types

| Value of HL7 message, | |
|---|---|
| field MSH-9 | Corresponding Event |
| A01 | Hospital Inpatient Admission |
| A03 | Discharge from emergency department |
| | or hospital |
| A04 | Admission to emergency department |
| A06 | Change an outpatient to an inpatient |
| | (typically an emergency visit becomes |
| | an inpatient admission) |
| PDI | Patient Discharge Instruction |

In another example, a hospital sends patient discharge instruction (PDI) HL7 messages shortly after a patient is discharged. A patient discharge event may be identified by the message types, for example, by the value within the HL7 segment OBR-21. In another example, a hospital may send discharge instructions in a HL7 message. For some hospitals, the PDI is contained within the Discharge Summary (which can take up to 72 hours to be sent out) and in others it is a separate message that is sent much closer to the actual discharge. Even in those hospitals in which the PDI is included in a Discharge Summary, having the more prompt PDI notification is seen as a benefit to physicians that have follow-up care responsibilities in the event of post-discharge complications upon a patient's discharge.

In another example, the message processor 310 may extract the type of the raw message. For example, the type of a message may trigger ADT events as required by the ADT triggers 346. The message processor 310 may extract other message component from the raw messages as needed by any other triggers 348.

In one embodiment of the present teaching, the message processor 310 stores the message components in the message store 370. In another embodiment of the present teaching, the message processor 310 stores the raw message in the message store 370. In still another embodiment of the present teaching, the message processor 310 stores both the raw message and processed message in the message store 370.

In one embodiment of the present teaching, the message processor 310 may directly send message components to event trigger logic 340. For example, the message processor 310 may extract a list of keywords from the raw message into a keyword component and sends the keyword message component), to the key word triggers 342. In this example, all key word triggers in the keyword trigger 342 are tested.

In another embodiment of the present teaching, the message processor 310 may send a message component to triggers that the source entity has subscription to. The event subscription module 320 determines a subset of the triggers that the source entity has subscribed. Using the example above, the message processor 310 may send the keyword component to the subset of keyword triggers, as determined by the event subscription module 320. In this example, the subsets of keyword triggers that are subscribed by the source entity are tested.

An event can be detected by examining whether the message satisfies the trigger logic associated with the event. In one embodiment of the present teaching, the event center 300 includes a trigger logic 340 which includes definitions for all events.

In one embodiment of the present teaching, the event trigger logic 340 includes keyword triggers 342 which stores event definitions that are triggered by one or more key words. For example, an event may be defined as having a keyword “diabetes” anywhere in the message body. In another example, an event may be defined as when the received message includes both key words “diabetes” and “Metformin.” In another example, an event may be defined as a search string on potential fields from the HL7 message. For example, the event is defined as finding loosely codified values in a free text HL7 field, such as lab/micro/rad result fields. In still another example, an event may be defined as a positive result based on a fuzzy logic search, or a particular search algorithm.

The event trigger logic 340 may include person triggers 344 which may trigger events based on the identity of a person, such as, for example, a particular patient, or a particular physician.

The event trigger logic 340 may include ADT triggers 346 which may trigger events based on ADT messages. ADT event may be identified when the type of the received message is an ADT message. In one embodiment of the present teaching, various events relate to ADT messages can be configured via a user interface to create ADT event triggers.

The event trigger 340 may include other triggers 348 which may trigger events based on other pre-defined conditions. For example, other triggers 348 may trigger a medical non-adherence event when a medical-non-adherence message is received. In another example, other triggers 348 may trigger patient EHR publication event when a patient EHR publication message is received.

In one embodiment, the trigger logic 340 receives message components from the message processor 310 and applies all triggers that applicable to the message component. In another embodiment, the trigger logic 340 applies a subset of triggers as selected by the event subscription 320. The event trigger logic 340 may also apply triggers that are selected by responsive events 360.

The event trigger 340 determines whether an event has occurred by examining the trigger logic for that event in light of the received message or message component(s). The event is detected when the trigger logic for the event, i.e., the pre-defined conditions for the event are satisfied. In one embodiment of the present teaching, the event trigger 340 sends the event id of the detected event to the event generator 350. In another embodiment of the present teaching, the event trigger 340 sends the event id and the message component that triggered the event to the event generator 350.

In one embodiment of the present teaching, the event center 300 includes an event generator 350 that generates events that are detected by the event trigger logic 340 and sends the generated events to the workflow systems 400. In one embodiment of the present teaching, a generated event includes information, such as, for example, the source entity of the event and the event id. In another embodiment of the present teaching, the event also includes message components associated with the event. In another embodiment of the present teaching, the event includes the raw message as received In one embodiment of the present teaching, the event center 300 includes an event subscription module 320 that defines a list of events that are related a particular source entity. As shown below in Table 2, the event subscription module 320 may include a list of events as identified by their event ids for each source entity. In this example, hospital A subscribes to four events as identified by their event ids 0010, 0030, 0040, 0050; hospital B subscribes to one event 0010. As discussed further below, event 0010 triggers workflows for PDI notifications for the source entity. See Table 3, “Event Actions.” As a result, the event 0010 may initiate workflow for PDI notifications for hospital A, which shall be executed based on hospital A's workflow settings. The same event 0010 may initiate a work flow for PDI notifications for hospital B, executed based on hospital B's workflow settings.

TABLE 2
Event Subscriptions

| | |
|---|---|
| Hospital A | 0010 (PDI notification) |
| | 0030 (diabetes and metformin |
| | keywords) |
| | 0040 (hospital A recently |
| | discharged patients) |
| | 0050 (critical lab value |
| | reported from lab A) |
| Hospital B | 0010 (PDI notification) |
| Lab A | 0050 (critical lab value |
| | notification) |
| Provider X | 0060 (my physician is mentioned) |
| Pharmacy Z | 0070 (medical non-adherence) |
| Patient N | 0080 (patient PHR publication) |

TABLE 3
Event Definitions

| Event ID | Event Trigger Definition | Event Actions (Workflow) |
|---|---|---|
| 0010 | Message type = PDI | #1 workflow on PDI notification |
| | | using entity rule of the message |
| | | source entity |
| 0030 | Includes key | #2 work flow to notify |
| | word “diabetes” | subscribed entities on diabetes |
| | or “Metformin” | care |
| 0040 | Subject patient is on | #3 workflow to notify hospital |
| | hospital A's recent | A's readmission warning system |
| | discharged patient list | |
| 0050 | Message type = | #4 Workflow to report lab value |
| | Critical lab value | to subject patient, and to the |
| | found | ordering physician |
| 0060 | A physician in the message | #5 workflow to notify the |
| | body is on Provider X's | physician of the message |
| | list of currently practicing | |
| | physicians | |
| 0070 | Message type = Medical | #6 workflow to notify patient |
| | non-adherence | about the unfilled prescription |
| | | using the entity rule of the |
| | | source entity |
| 0080 | Message type = patient | #7 workflow to notify physicians |
| | EHR publication | associated with the patient |

Similarly, as shown in Table 2 and Table 3, the hospital A subscribes an event 0030 which is triggered by the condition that keyword “diabetes” or “Metformin” appearing in the received messages. Once such keywords are detected, an event 0030 is generated for the hospital A. The event 0030 allows hospital A to initiate a work flow #2, which may notify research entities on diabetes care of the that event (keyword “diabetes” or “Metformin” found). Similarly, the hospital A subscribes an event 0040 wherein the subject patient in the received message is a recently discharged patient of hospital A. The occurrence of the event 0040 initiates a workflow #3, which may provide the received message to hospital A's readmission warning system/workflow.

In the same example, as shown in Table 1, in addition to hospital A and hospital B, the event subscription module 320 also includes subscriptions for other source entities, such as Lab A, Provider X, Pharmacy Z and Patient N; each source entity subscribes to one event, as identified by event id 0050, 0060, 0070 and 0080 respectively. In a similar mechanism as described above with respect to hospital A, Lab A subscribes to an event 0050 (Critical Lab Value found event), which may initiate a workflow #4 to report lab value to subject patient, and to the ordering physician.

Provider X subscribes to an event 0060, (my practicing physician is mentioned in the message body), which may initiate a workflow #5 to notify the physician of the message. Pharmacy Z subscribes to an event 0070, (medical non-adherence found), which may initiate a workflow #6 to notify subject patient about the unfilled prescription. See Table 3, “Event Definitions.” A Patient N subscribes to an event 0080 (patient has published an EHR), which may initiate workflow #7 to notify all physicians associated with patient N.

In one embodiment of the present teaching, the event center 300 includes a responsive events module 360 which defines a list of possible responsive events that could be triggered based on an occurrence of a current event. As seen in Table 3, an event typically initiates one workflow of the source entity. The responsive events 360 module allows a particular event from one source entity to trigger additional responsive events in any collaborative entity in health data source 110, including the source entity itself, assuming the source entity consents to share the received message with the collaborative entities. The additional responsive events, once detected, may initiate additional workflows by the collaborative entities.

For example, a current event 0050 (critical lab value found) is detected, such as, for example, by the event trigger logic 340, which may initiate a workflow #4 to report lab value to subject patient, and to the ordering physician based on Lab A's settings. The responsive events module 360 receives the event id 0050 from the event logic 340 and determines, as shown in Table 4, the event 0050 has a responsive event 0040.

The responsive events module 360 sends the responsive event id 0040 to the event trigger logic 340 to determine if event 0040 can be triggered—the event trigger logic checks if the subject patient is a recently discharged patient of hospital A. As a result, if the critical lab value found in event 0050 is a message about a patient who is also on the recently discharged patient list of hospital A, a new event 0040 can be generated, which may initiate a workflow in hospital A's readmission warning system/workflow.

In another example, a detected event 0070 (Pharmacy A reports medical non-adherence) may trigger a responsive event 0070 if the subject patient of the medical non-adherence is also on hospital A's recently discharged patient list, a new event 0040 can be generated, which may initiate a workflow in hospital A's readmission warning system/workflow.

In another example, a detected event 0080 (Patient N publishes an EHR) may trigger any of the three responsive events 0030, 0040 and 0060. More specifically, if conditions for event 0030 trigger are satisfied, i.e., the published HER includes key word “diabetes” or “Metformin” as seen in Table 3, an event 0030 may be generated to initiate work flow to notify research entities on diabetes care.

Similarly, if conditions for event 0040 trigger are satisfied, i.e., the subject patient of the published HER is a recently discharged patient of hospital A, as seen in Table 3, an event 0040 may be generated, which may initiate a workflow in hospital A's readmission warning system/workflow.

Moreover, if conditions for event 0060 trigger are satisfied, i.e., the published EHR includes a physician who is currently practicing in Provider X's facility, as seen in Table 2, an event 0060 may be generated to initiate work flow to notify the physician about the published EHR of patient N.

In one embodiment of the present teaching, a collaborate entity may configure its responsive events rules in its entity rules 122. For example, the collaborate entity may respond to an event from a source entity by configuring one or many responsive events that may initiate workflows in the collaborate entity. Using the example as shown in Table 3, hospital A may select to respond to a critical lab value event 0050 by Lab A. In this example, Hospital A configures one responsive event 0040 for event 0050, which checks whether the critical lab value report's subject patient is on the hospital A's recent discharged patient list. As a result, if the responsive event 0040 is triggered, i.e., the critical lab report is indeed about a recently discharged patient from hospital, then a workflow #3 will be initiated where hospital A's readmission warning system gets notified of the critical lab value report. See Table 3.

In one embodiment of the present teaching, the Healthcare Event Response and Communication Center 120 searches and aggregates responsive event rules from various entities so that it may look up all responsive events from various entities that relate to a particular event. For example, the Healthcare Event Response and Communication Center 120 may aggregate a central responsive events table, such as shown in Table 4. In another example, the Healthcare Event Response and Communication Center 120 may create a responsive events map which allows multistep look up and may allow scalable building of more responsive events upon an existing responsive event map. The responsive events map may allow cascading effects of responsive events.

TABLE 4
Responsive Events

| Event ID | Responsive events | Description |
|---|---|---|
| 0050 | 0040 | Hospital A wants to check if |
| (critical lab | (Subject patient is | the reported critical lab values |
| value reported | on hospital A's | is associated with one of Hospital |
| from lab A) | recent discharged | A's recent discharged patients. |
| | patient list) | |
| 0070 | 0040 | Hospital A wants to check if |
| (medical non- | (Subject patient is | the reported medical |
| adherence) | on hospital A's | non-adherences is associated |
| | recent discharged | with one of Hospital |
| | patient list) | A's recent discharged |
| | | patients. |
| 0080 | 0030 | Research entities on diabetes |
| (patient PHR | (diabetes and | care want to check all |
| publication) | metformin | published patient record |
| | keywords | |
| | 0040 (Subject | Hospital A wants to know |
| | patient is on | published patient record |
| | hospital A's | associated with its recent |
| | recent discharged | discharged patients |
| | patient list) | |
| | 0060 (A physician | Provider X wants to collect all |
| | in the message | published patient record |
| | body is on | where its practicing |
| | Provider X's list | physician is mentioned |
| | of currently | |
| | practicing | |
| | physicians | |

FIG. 3(b) is a flowchart of an exemplary flowchart of an exemplary process in which an event center 300 operates, according to an embodiment of the present teaching. Upon receiving a message, the message processor 310 determines the source entity of the message, such as, for example, a hospital A, a hospital B, a Lab A, or a provider X.

The message processor 310 applies the formatting rules specific to the source entity and extracts meaningful content from the received message at 310b.

The message processor 310 may look up events subscribed by the source entity as defined in event subscription module 320 at 320b. If the event subscription module 320 found one or many subscribed events by the source entity at 330b, the event trigger logic 340 may further acts to detect these events at 350b. For example, the event trigger logic 340 may test the event trigger that corresponds to an event by examining whether the conditions in the event trigger are satisfied based on the received message. The event trigger logic 340 may test all event triggers of the subscribed events found at 330b.

Upon detection of an event at 370b, the event trigger logic 340 may pass the detected event id and relevant data to the event generator 350. The event generator 350 may create an event at 360b. The created event may include, for example, a source entity id, an event id, and data related to the event. The event generator 350 may send the created event to the workflow system at 380b.

Additionally, the event trigger logic may send a detected event to the responsive events module 360. The responsive events module 360 determines whether there are any responsive events to the detected event at 370b.

If the responsive events module 360 found one or more responsive events at 372b, the event trigger logic 340 may further acts to detect these responsive events at 374b. For example, the event trigger logic 340 may test the event triggers associated with all event triggers of the responsive events.

Upon detection of an event at 374b, the event trigger logic 340 may pass the detected event id and relevant data to the event generator 350. The event generator 350 may create an event at 360b. The created event may include, for example, a source entity id, an event id, and data related to the event. The event generator 350 may send the created event to the workflow system at 380b.

FIG. 4(a) shows an exemplary system diagram of a workflow system 400, according to an embodiment of the present teaching. The workflow system 400 may process a received event, for example, by activating a pre-defined workflow associated with the received event. In one embodiment of the present teaching, an activated workflow in the workflow system 400 may automatically outputs notifications at a predetermined time based on the business process and schedules associated with the activated workflow.

The workflow system 400 is driven by real-time data events, such as, for example, an event generated by the event center 300 upon analyzing data from a real-time message. The workflow system 400 uses an automated approach to manage the release of information, such as, for example, information from the real-time message, with predesigned workflows.

More specifically, the workflow system 400 manages the timing of information release, for example, by dispatching notifications according to pre-defined timing schedules in the workflows.

Further, the workflow system 400 also manages the content, for example, by creating customized notifications at an organizational level based on the organization's rules which are configured, for example, in organization rules 124. The workflow system also manages the recipient selections, by applying recipient selection rules of the organization.

Moreover, the workflow system 400 also manages the delivery mechanisms for the information release as relate to each individual recipient, for example, by applying specific recipient rules, such as, for example, recipient rules configured in the recipient rules 124.

In one embodiment of the present teaching, as shown in FIG. 4(a), the workflow system 400 manages the information release by sending out notifications. A notification generally refers to data content delivered in an appropriate format to a certain system or device. For example, a notification may be a text message or an alert delivered as a SMS message to a mobile phone. A notification may also be an email delivered to an email address that is accessible from various devices, such as a computer, a laptop, a mobile phone or any mobile device. For example, a secure email system AKARIO MAIL by DRFIRST. A notification may be configured to initiate or participate in a chat system, such as, for example, AKARIO BACKLINE CHAT by DRFIRST.

A notification may also be a voice message that can be delivered to voicemail box. A notification may be an image that can be faxed to a fax machine. A notification may be a video delivered to a public website. A notification may also be a combination of text, image, audio video contents delivered to an online data access provider.

A notification may also be a data package that is operable to be imported into a user's calendar. A notification may also be a data package that is operable to be exported to a particular entity in the health data source 110. A notification may also be a document or an event that is operable to be processed by a workflow system.

In one embodiment of the present teaching, a notification includes a complete set of information, such as data content, delivery address of a targeted device or system. The notification is sent out by the workflow system 400 at the right time. In one embodiment of the present teaching, the notification may be delivered to targeted human users on a preferred, by a delivery engine 500.

In one embodiment of the present teaching, a workflow system 400 includes a workflow definitions module 410 which provides a repository of workflow definitions for various business processes practiced by various entities in the health data source 110. In one embodiment of the present teaching, the workflow definitions 410 uses business process management (BPM) approaches to define the business processes associated with a workflow. In another embodiment of the present teaching, the workflow definitions 410 uses a rules engine to automate business processes.

In one example, a workflow is defined specifically to a particular organization. In another example, a workflow may be used by all organizations. In still another example, a workflow defining some common functions for a type of organizations may be used by a number of organizations of a same type, such as, for example, a ADT notification workflow for all hospitals. An organization may configure to select all or a subset of the common functions in the entity rules 122 to define its own workflow.

A workflow definition that is shared by multiple organizations may be configured by organization specific rules. In one example, the workflow definitions 410 may incorporate rules as defined in entity rules 122 and/or recipient rules 124. For example, a workflow may define a scheduled delivery time to be on a working day, such as, for example, a non-holiday weekday. Organizations of different country have different holidays. Different organizations of the same country may also vary as to which holidays the organization chooses to take. Even the same organization may vary its holiday schedule from year to year.

In one embodiment of the present teaching, the organization may configure its holiday schedule as a rule in the entity rules 122. By referencing to the holiday schedule rule of the organization, the workflow adjusts automatically to the organization's selection of holidays.

Similarly, a recipient, such as a doctor, may define his/her own “working day” in the recipient rules 124. In one example, an ER doctor may define his working day as specific calendar days when he is in the ER. In another example, a doctor may exclude his vacation days from being a “working day” in a workflow. A workflow definition may be configured to apply recipient rules for all recipients of a notification.

In one embodiment of the present teaching, the workflow system 400 includes an event to workflow index module 420, which identifies one or many workflows associated with the event from a source entity. In one embodiment of the present teaching, a workflow id is used to identify the workflow from the workflow definition 410.

Using the example above, as shown in Table 3, the workflow index unit 420 is configured to associate an event with a particular workflow, as identified by, for example, a workflow id. More specifically, a PDI event 0010 is associated with a workflow for PDI notification, as identified by workflow id #1. The workflow #1, as defined in the workflow definitions 410, may include, for example, very specific rules or BPMs about PDI notification. In another example, event to workflow index unit 420 associates a critical lab value event 0050 d with a workflow with workflow id #4. The workflow #4, as defined in the workflow definitions 410, includes, for example, specific rules or BPMs about reporting critical lab values to the subject patient and the ordering physician.

The workflow system 400 also includes administrator user interfaces 430 where an administrator may configure workflow definitions for different entities. The administrator user interfaces may also include user interface to configure organization rules 122. The administrator user interfaces may also include user interface to configure recipient rules 124, as shown in FIG. 4(c) as discussed further below.

A workflow engine 440 is a component that manages the execution of individual workflow instances. The workflow engine 440 tracks the status of each workflow instance, determines what task is next in queue, the people for executing the task, and transports the data needed for the task from the resources.

A workflow instance is initiated by a received event. For example, a patient discharge event from hospital A is captured by the event center 300 and passed into the workflow system 400. Upon receiving the event, the workflow engine initiates a patient discharge workflow instance based on related settings by hospital A. An active workflow instance controls the timing of the PDI notification.

The workflow system 400 may include knowledge base 450 and analytics engine 460 that may provide current and predictive views of health data, support better decision with respect to patient care, or provide specific analysis for medical research purposes, for example, as driven by user demand. In one embodiment of the present teaching, the workflow system 400 includes a subscription workflow which provides value-added data to subscribers. For example, a subscriber would like to see what drug is prescribed for diabetes the most.

In one embodiment of the present teaching, a subscriber manager 458 is configured to manage the subscribers, as well as associated subscriber content, subscriber workflow definitions.

The knowledge base 450 may include a number of data repositories. In one embodiment of the present teaching, the knowledge base 450 routinely extracts meaningful data from the received messages. The knowledge base 450 may import contents from the message components 330 in the event center 300; the knowledge base 450 may extract data from the message store 370; the knowledge base 450 may also import data from entities from the health data source 110.

In one example, the knowledge base 450 may include a patient medical history data manager 452 which stores EHRs communicated through the Healthcare Event Response and Communication Center 120. In another example, the knowledge base 450 may include a patient provider identity and relationship manager 456 which stores various form of identity information of a patient or a doctor. The patient provider identity and relationship manager 456 may also include, for example, all providers that are associated with a patient as obtained from data communicated by various entities in the health data source 110 over time.

FIG. 4(b) is a flowchart of an exemplary flowchart of an exemplary process in which a workflow system 400 operates, according to an embodiment of the present teaching. Upon receiving an event from a source entity at 410b, the event to workflow index 420 may determine which workflow should be initiated in response to the event from the source entity. For example, the event to workflow index 420 may provide a workflow id, which uniquely identifies a workflow, as defined in the workflow definitions 410.

At 430b, if the event to workflow index 420 found a workflow in response to the event, the workflow definitions 410 may find the definition for the workflow.

In one embodiment of the present teaching, the workflow engine 440 may initiate the workflow and create a workflow instance based on the workflow definition at 440b. In another embodiment of the present teaching, the workflow engine 440 may consult organization rules 122 for rules applicable to the source entity and for the workflow definition and configure the workflow definition based on applicable rules.

In one embodiment of the present teaching, the workflow engine 440 executes the workflow instance, which may embody applicable organization rules of the source entity. The workflow instance may derive a list of recipients that are targeted to receive notifications from the workflow. The workflow engine 440 may search, for example, in the in the recipient rules 124, applicable rules for receiving notifications for each targeted recipient on the recipient list.

In one embodiment of the present teaching, the workflow engine 440 may construct notifications to the targeted list of recipients. The workflow engine 440 may apply the applicable recipient rules found as relate to notification corresponding recipient at 460b. An example of the recipient rules are described further in FIG. 4(c). The workflow engine may send constructed notifications to the recipients at 470b.

FIG. 4(c) shows an exemplary user interface where the recipient rules for a recipient are defined. In this example, the recipient defines the rules to receive notifications in both AKARIO Mail and email format, providing mail address for each. The recipient elects to receive notification when any new message appears in the inbox, or when a new message is received with documents, such as ADT, DSS and TOC documents. The recipient elects not to receive notifications for new messages with PDI and Lab results.

The Recipient rule, as shown in FIG. 4(c), also includes an option for the recipient to redirect messages to a different recipient. For example, a recipient doctor may prefer a care coordinator John Smith to receive ADT notifications on inpatient admissions (A01). The recipient doctor may prefer a dedicated nurse, Mary Jones, to receive ADT notifications on emergency admission (A04) and patient discharge instructions (PDI).

FIG. 5 shows an exemplary system diagram of a delivery engine 500, according to an embodiment of the present teaching. The delivery engine 500 is operable to deliver data to a variety of receiving devices or systems. For example, the delivery engine 500 may send a text message or an alert delivered as a SMS message to a mobile phone. The delivery engine 500 may also send an email to an email address that is accessible from various devices, such as a computer, a laptop, a mobile phone or any mobile device. The delivery engine 500 may also send a secure email system AKARIO MAIL by DRFIRST. The delivery engine 500 may initiate or participate in a chat system, such as, for example, AKARIO BACKLINE CHAT by DRFIRST.

The delivery engine 500 may send a voice message that can be delivered to voicemail box. The delivery engine 500 may fax an image to a fax machine. The delivery engine 500 may upload a video to a public website. The delivery engine 500 may also provide a combination of text, image, audio, video contents to an online data access provider.

The delivery engine 500 may also construct a data package that is operable to be incorporated into a recipient's calendar. The delivery engine 500 may also construct a data package that is operable to be exported to a particular entity in the health data source 110. The delivery engine 500 may deliver a document or an event that is operable to be processed by a workflow system.

In one embodiment of the present teaching, the delivery engine includes a delivery channel selector 510 that is operable to choose one or more delivery channels for delivering data contents from a notification. A delivery channel may include, for example, an email channel, a secure AKARIO mail channel, a text message channel, an AKARIO BACKLINE chat channel. The delivery channel may also include a voice message channel, a website video upload channel, a data upload to online data access provider channel. The delivery channel may also include a data export channel to any entity in the health data source 110, or an event delivery channel to a workflow system.

In one embodiment of the present teaching, delivery channel selector 510 is operable to construct deliverable content for a selected delivery channel based on the received notification. In another embodiment of the present teaching, delivery channel selector 510 may apply recipient rules as defined in the recipient rules 124 for the actual data delivery. In one example, a recipient rule may configure actions in case of delivery failure. One particular recipient may require the delivery engine 500 to re-try a number of times. Another recipient may require the delivery engine 500 to re-try after a pre-determined time.

The delivery engine 500 may also include an export data formatting module 520 that formats data for exporting to a target entity in the health data sources 110. The delivery engine 500 may also include connectors 530 for communicating with external systems, such as, for example, entities in the health data source 100, a document management application server or affiliated services.

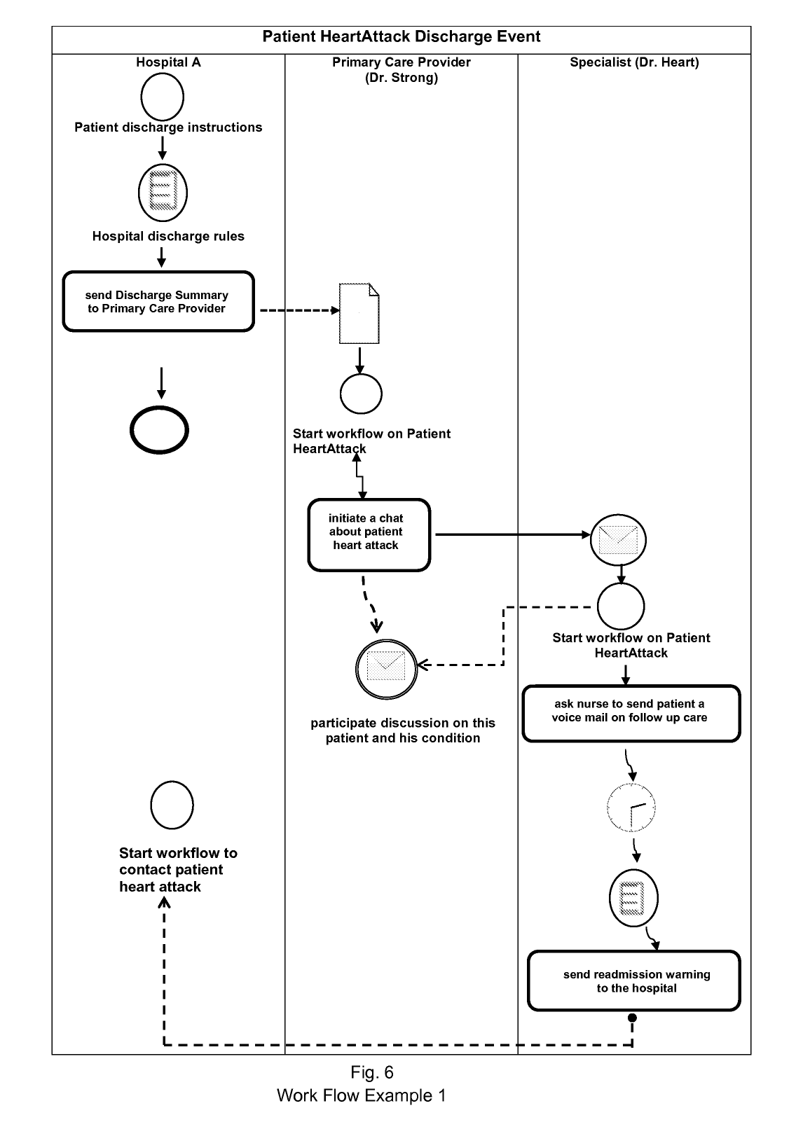

FIG. 6 shows exemplary workflow diagrams, according to an embodiment of the present teaching. First, hospital A sends a PDI message to the Healthcare Event Response and Communication Center 120. Upon receiving the message, the event center 300 of the Healthcare Event Response and Communication Center 120 creates a PDI event from hospital A, which activates a PDI notification workflow for hospital A in the workflow system 400. The PDI notification workflow is predefined to send the PDI document to the primary care provider, Dr. Strong. The workflow system further examines the recipient rules for Dr. Strong, whose preference is set to receive PDI documents right away. As a result, the PDI document is delivered, hospital A's PDI notification workflow ends.

Secondly, upon receipt of the PDI document for Dr. Strong at his practice, Provider X, via the Healthcare Event Response and Communication Center 120, the PDI document may trigger event for the PDI document processing workflow. The PDI document processing workflow for the Provider X is configured to send PDI notification to the specialist doctor (Dr. Heart), and to initiate an AKARIO BACKLINE chat that includes both the primary care doctor (Dr. Strong) and the specialist doctor (Dr. Heart) with topic on the subject patient.

Third, upon receipt of the PDI notification, from Dr. Strong of Provider X facility to the Provider Y facility via the Healthcare Event Response and Communication Center 120, the PDI notification may trigger an event for the Provider Y to activate a follow up care work flow for the subject patient. The follow up care work flow first send a voice mail to the patient based on the patient contact information on the PDI notification. The follow up care work flow further monitors Provider Y's patient visit log for a pre-determined 14 days. At the end of the 14 days, an absence of the subject patient's visit to the Provider Y results a notification from Provider Y to hospital A “no follow up care alert” for the subject patient.

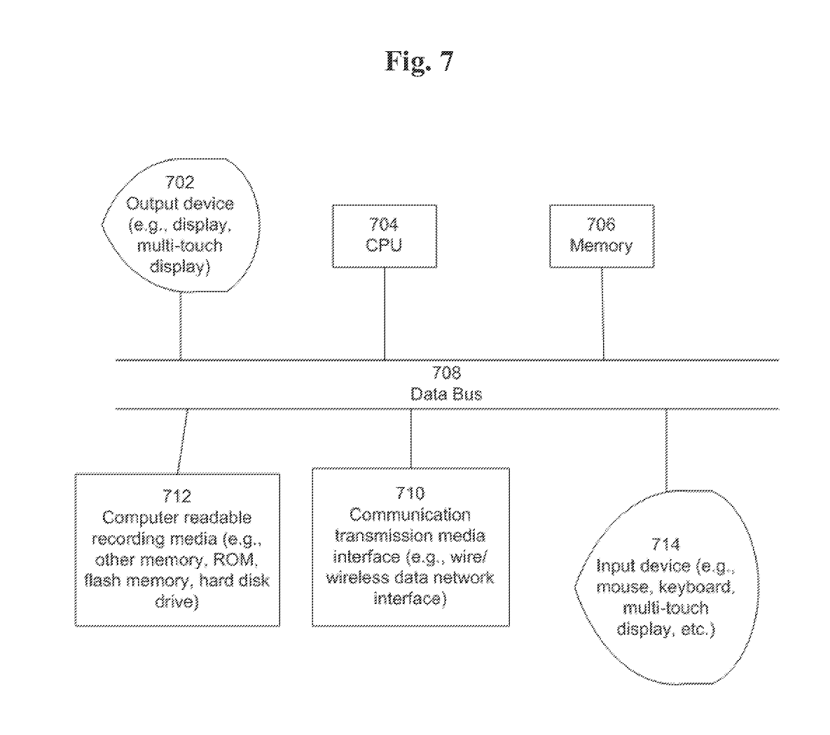

According to an aspect of the embodiments of the present teaching, any combinations of one or more of the described features, functions, operations, and/or benefits can be provided. The word (prefix or suffix article) “a” refers to one or more. A combination can be any one of or a plurality. The embodiments can be implemented as an apparatus (a machine) that includes processing hardware configured, for example, by way of software executed by the processing hardware and/or by hardware logic circuitry, to perform the described features, functions, operations, and/or benefits. A computing apparatus, such as (in a non-limiting example) any computer or computer processor that includes processing hardware and can store, receive, retrieve, process and/or output data and/or communicate (network) with other computing apparatuses. According to an aspect of an embodiment, the described features, functions, operations, and/or benefits can be implemented by and/or use processing hardware and/or software executed by processing hardware. For example, a computing apparatus as illustrated in FIG. 7 can comprise a central processing unit (CPU) or computing processing system 704 (e.g., one or more processing devices (e.g., chipset(s), including memory, etc.) that processes or executes instructions, namely software/program, stored in the memory 706 and/or computer readable media 712, transmission communication interface (network interface) 710, input device 714, and/or an output device 702, for example, a display device, a printing device, and which are coupled (directly or indirectly) to each other, for example, can be in communication among each other through one or more data communication buses 708.

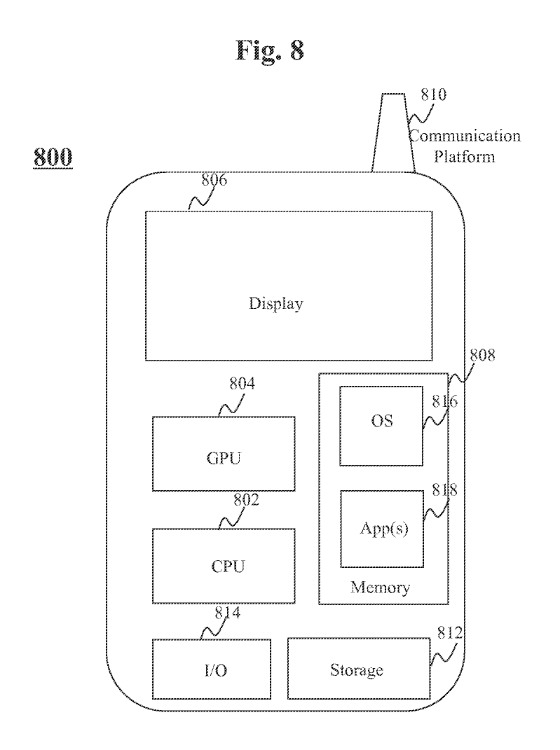

FIG. 8 depicts the architecture of a mobile device which can be used to realize a specialized system implementing the present teaching. In this example, the user device by which end users could use for accessing the Healthcare Event Response and Communication Center 120 is a mobile device 800, including but is not limited to, a smart phone, a tablet, a wearable device (e.g., watch) a music player, a handled gaming console, a global positioning system (GPS) receiver. The mobile device 800 in this example includes one or more central processing units (CPUs) 802, one or more graphic processing units (GPUs) 804, a display 806, a memory 808, a communication platform 810, such as a wireless communication module, storage 812, and one or more input/output (I/O) devices 814. Any other suitable component, such as but not limited to a system bus or a controller (not shown), may also be included in the mobile device 800. As shown in FIG. 8, a mobile operating system 816, e.g., iOS, Android, Windows Phone, etc., and one or more local client applications 818 may be loaded into the memory 808 from the storage 812 in order to be executed by the CPU 802. The local client applications 818 may include a browser or any other suitable mobile apps for accessing the Healthcare Event Response and Communication Center 120 on the mobile device 800. Execution of the local client applications 818 may cause the mobile device 800 to perform the processing as described above in the present teaching. For example, the display of the user interfaces may be made by the GPU 804 in conjunction with the display 806. User interactions with the user interfaces may be achieved via the I/O devices 814 and provided to the Healthcare Event Response and Communication Center 120 via the communication platform 810.

In addition, an apparatus can include one or more apparatuses in computer network communication with each other or other devices. In addition, a computer processor can refer to one or more computer processors in one or more apparatuses or any combinations of one or more computer processors and/or apparatuses. An aspect of an embodiment relates to causing and/or configuring one or more apparatuses and/or computer processors to execute the described operations. The results produced can be output to an output device, for example, displayed on the display. An apparatus or device refers to a physical machine that performs operations, for example, a computer (physical computing hardware or machinery) that implement or execute instructions, for example, execute instructions by way of software, which is code executed by computing hardware including a programmable chip (chipset, computer processor, electronic component), and/or implement instructions by way of computing hardware (e.g., in circuitry, electronic components in integrated circuits, etc.)—collectively referred to as hardware processor(s), to achieve the functions or operations being described. The functions of embodiments described can be implemented in any type of apparatus that can execute instructions or code.

More particularly, programming or configuring or causing an apparatus or device, for example, a computer, to execute the described functions of embodiments of the present teaching creates a new machine where in case of a computer a general purpose computer in effect becomes a special purpose computer once it is programmed or configured or caused to perform particular functions of the embodiments of the present teaching pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

The many features of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A system for handling healthcare messages from various entities in a healthcare community, comprising:
a message processor configured to receive a healthcare message and process the healthcare message;
an event trigger logic configured to automatically identify one or more healthcare events;
an event subscription module configured to identify, for each identified healthcare event, one or more responsive entities that are configured to be responsive to the healthcare event, wherein each responsive entity is associated with one or more healthcare workflows that are configured to receive the healthcare event; and
an event generator configured to provide, in real-time, each identified healthcare event to each of the one or more responsive healthcare workflows with respect to each responsive entity.

2. A method implemented on a computing device having at least one processor, storage, and a communication platform for handling healthcare messages from various entities in a healthcare community, comprising:
receiving a healthcare message;
processing the healthcare message to automatically identify one or more healthcare events;
identifying, for each identified healthcare event, one or more responsive entities that are configured to be responsive to the healthcare event, wherein each responsive entity is associated with one or more healthcare workflows that are configured to receive the healthcare event; and
providing, in real-time, each identified healthcare event to each of the one or more responsive healthcare workflows with respect to each responsive entity.

3. The method of claim 2, wherein the step of providing further includes:
dynamically generating a responsive healthcare workflow as associated with the identified healthcare event;
instantiating the responsive healthcare workflow with a configuration that is associated with the responsive entity; and
executing the responsive healthcare workflow based on the healthcare event.

4. The method of claim 2, wherein a healthcare event is automatically identified when information related to the healthcare message satisfies a condition predefined for the healthcare event.

5. The method of claim 2, wherein the healthcare message is processed to extract information related to at least one of:
a source from which the healthcare message is received;
a type of the healthcare message;
one or more keywords in the healthcare message;
a subject patient related to the healthcare message; and
one or more healthcare providers related to the healthcare message.

6. The method of claim 2, wherein identifying, for each identified healthcare event, one or more entities that are configured to be responsive to the healthcare event includes identifying one or more entities that are subscribing to receive the healthcare event.

7. The method of claim 2, wherein
the one or more healthcare events include at least a current healthcare event and a responsive healthcare event related to the current healthcare event; and
the responsive healthcare event is automatically identified when the current healthcare event is identified.

8. The method of claim 3, wherein executing the healthcare workflow based on the responsive healthcare event comprises:
sending a notification to recipients that relate to the responsive entity; and
dynamically changing status of the healthcare workflow.

9. The method of claim 8, wherein dynamically changing status of the healthcare workflow includes ending the healthcare workflow.

10. The method of claim 8, further comprising:
initiating a real-time chat that includes recipients that relate to the responsive entity and the notification.

11. The method of claim 8, wherein sending a notification to recipients that relate to the responsive entity includes sending notifications to recipients in real-time or at a time based on a configurable schedule that is associated with the responsive entity.

12. The method of claim 8, wherein sending a notification to recipients that relate to the responsive entity includes sending notifications to recipients in real-time or at a time based on a configurable schedule that is associated with an individual recipient.

13. The method of claim 8, wherein sending a notification to recipients that relate to the responsive entity includes sending notifications to recipients based on a configurable format that that is associated with the responsive entity.

14. The method of claim 8, wherein sending a notification to recipients that relate to the responsive entity includes sending notifications to recipients based on a configurable notification address that that is associated with an individual recipient.

15. The method of claim 8, wherein sending a notification to recipients that relate to the responsive entity includes sending a healthcare event and related information to a workflow in the responsive entity.

16. The method of claim 2, further comprising:
providing an interface to the one or more entities to facilitate the one or more entities to configure at least one of the one or more healthcare workflows.

17. The method of claim 2, wherein the one or more entities include at least one of:
a hospital;
a lab;
a physician;
a payer;
a pharmacy; and
a patient.

18. A method implemented on a computing device having at least one processor, storage, and a communication platform for dynamically generating healthcare workflows, comprising:
receiving a healthcare event as associated with a responsive entity;
identifying one or more healthcare workflows that are associated with the healthcare event and the responsive entity;
instantiating the identified one or more healthcare workflows while applying configurations that are associated with the responsive entity; and
executing each instantiated healthcare workflow based on the information that relate to the received healthcare event.

19. The method of claim 18, wherein executing an instantiated healthcare workflow based on the information that relate to the received healthcare event includes terminating the instantiated healthcare workflow.

20. The method of claim 18, wherein executing each instantiated healthcare workflow based on the information that relate to the received healthcare event further includes:
initiating an analytics inquiry to a knowledge base wherein the inquiry relate to the received healthcare event;
obtaining an answer to the inquiry from the knowledge base; and
generating a health message that includes information from the obtained answer.

21. The method of claim 20, further comprising:
sending the generated health message to a system that is operable to handle healthcare messages from various entities in a healthcare community.
